(19) United States
(12) Patent Application Publication
(10) Pub. No.: US 2022/0058941 A1
(43) Pub. Date: Feb. 24, 2022

(54) FALSE ALARM REDUCTION SYSTEM, METHOD AND APPARATUS

(71) Applicant: Ecolink Intelligent Technology, Inc., Carlsbad, CA (US)

(72) Inventor: Michael Lamb, Rancho Santa Fe, CA (US)

(21) Appl. No.: 16/998,394

(22) Filed: Aug. 20, 2020

(51) Int. Cl. G08B 29/16; G08B 26/00; G08B 25/10; G08B 25/00; G08B 3/10; H04W 4/80

(52) U.S. Cl. CPC G08B 29/16; G08B 26/007; H04W 4/80; G08B 25/008; G08B 3/10; G08B 25/10

(57) ABSTRACT

Systems, methods and apparatus are described for reducing the occurrence of false alarms by determining the identify of people, typically via their mobile devices, in or near a monitored premises. A security system employing the embodiments described herein monitors a home or business to determine the presence of mobile devices in or near the premises, and determines whether such mobile devices are authorized, or not, to enter the premises after the security system has been armed. When an intrusion is detected, the security system determines whether any unauthorized mobile devices are present in or near the premises. If so, one or more escalated alarm responses are initiated by the security system. If no unauthorized mobile devices are in or near the premises when intrusion is detected, the security system ignores the intrusion and refrains from performing the escalated alarm responses.

### BACKGROUND

### Field of Use

The present application relates to the field of home and business security systems. More specifically, the present application relates to systems, apparatus and methods for reducing false alarms in such security systems.

### Description of the Related Art

Security systems for homes and businesses have been around for many years. Often, these systems make use of barrier alarm devices, such as door and window sensors, and other sensors such as motion detectors, sound detectors, glass break sensors, etc. These sensors transmit wireless alarms signals to a central security panel, gateway or hub inside a home or business when triggered. The central security panel, gateway or hub may cause an escalated alarm response to occur when such alarm signals are received while the security system is “armed”, such as to forward alarm signals to a remote monitoring center via a telephone system, cellular system, the Internet, etc., and/or cause a loud siren to sound at the location.

One problem with prior art security systems is the occurrence of false alarms. Often times, occupants forget that their security system is armed when they are home, and when a door or a window is opened by an occupant, the security panel, hub or gateway may contact a remote monitoring center, which may trigger a response from local authorities, wasting valuable public resources. Additionally, homeowners may be fined if too many false alarms occur within a certain time period. Further, occupants are often startled if a local siren is triggered inside the home, because the siren is deliberately designed to be very loud. Finally, owners are more likely to cancel monitoring services of their systems if false alarms become a common occurrence.

It would be desirable, then, to provide a security system that reduces the occurrence of false alarms.

### SUMMARY

The embodiments described herein relate to methods, systems, and apparatus for reducing false alarms in a security system. In one embodiment, a system is described, comprising one or more security sensors located in and around a monitored premises, a person/mobile identification device for determining an identification of a person via their mobile device in or near a monitored premises, and a central security monitoring device, comprising a receiver for receiving alarm signals from the one or more security sensors, a non-transient memory for storing processor-executable instructions and a list of authorized mobile devices that are authorized to enter the monitored premises, and a processor, coupled to the receiver and the memory, for executing the processor-executable instructions that causes the central security monitoring device to receive an alarm signal from one of the security sensors indicating intrusion into the monitored premises, in response to receiving the alarm signal, determine if there are any unauthorized mobile devices in or near the monitored premises, and ignore the alarm signal when no unauthorized mobile devices are in or near the monitored premises.

In another embodiment, a method for reducing false alarms in a security system is described, comprising receiving an alarm signal from a first security sensor monitored by the central security monitoring device, the alarm signal indicating intrusion into the monitored premises, in response to receiving the alarm signal, determining if there are any unauthorized mobile devices in or near a monitored premises where the central security monitoring device is located, and ignoring the alarm signal when no unauthorized mobile devices are in or near the monitored premises.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is a block diagram illustrating one embodiment of a security system in accordance with one embodiment of the principles discussed herein;

FIG. 2 is a functional block diagram of one embodiment of a central security monitoring device as shown in FIG. 1; and

FIG. 3 is a flow diagram illustrating one embodiment of a method performed by the central security monitoring device as shown in FIGS. 1 and 2 or a remote server as shown in FIG. 1.

### DETAILED DESCRIPTION

The present application relates to systems, methods and apparatus for reducing the occurrence of false alarms by determining the identify of people, typically via their mobile phones, in or near a monitored premises. In one embodiment, a security system monitors a home or business to determine the presence of mobile devices in or near the premises, and to determine whether persons associated with such mobile devices are authorized, or not, to enter the premises after the security system is armed. When an intrusion is detected by a security sensor, the security system determines whether any unauthorized persons are present in or near the premises by determining whether any unauthorized mobile devices are in or near the monitored premises. If so, an escalated alarm response occurs, such as contacting a remote monitoring center, sounding a local siren, causing a strobe light to flash, etc. If no unauthorized persons/mobile devices are in or near the monitored premises when intrusion is detected, the security system ignores the intrusion and refrains from performing the escalated alarm response.

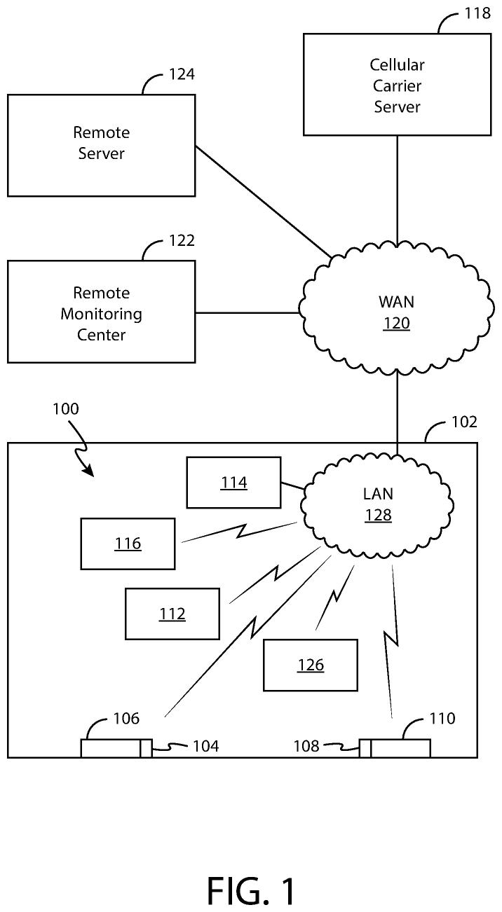

FIG. 1 is a block diagram illustrating one embodiment of a security system 100 in accordance the principles discussed herein. In this embodiment, a premises 102, such as a home or a business, is monitored by a number of security sensors as part of security system 100 to determine unauthorized entry into premises 102. In this example, a door sensor 104 monitors door 106 while a window sensor 108 monitors a window 110. Sensors 104 and 108, in this example, are both standard, well-known, wireless door/window sensors, each typically comprising a magnet and reed switch/transmitter assembly. When a door or window is opened, contact between the magnet and reed switch is broken and, in response, a wireless “alarm signal” is transmitted by the sensor.

Security system 100 may further comprise a motion sensor 112, placed inside premises 102 to detect movement of people inside premises 102. Security system 100 may additionally comprise other, well-known sensors, such as one or more garage door tilt sensors, glass break sensors, cameras, beam interruption detection devices, sound detectors, light detectors, and/or other sensors for determining intrusion into, or movement within, premises 102.

Security system 100 additionally comprises central security monitoring device 114, which monitors the security sensors for alarm signals transmitted by the security sensors upon detection of intrusion such as when a door or window is opened, or when motion is detected by motion sensor 112. Central security monitoring device 114 may communicate with remote monitoring center 122 via local-area network (LAN) 128. LAN 128 typically comprises a packet-based, limited range wireless communication network, such as a Wi-fi network, enabling communications between LAN-equipped devices in or near premises 102.

Unlike traditional security systems, security system 100 additionally comprises person/mobile identification device 114 that monitors premises 102 to determine identities of people and/or their mobile devices, such as cell phones, wearables, etc., in or near premises 102. Person/mobile identification device 114 may comprise one or more Bluetooth receivers or beacons, one or more cameras, and/or a cellular receiver or transceiver. Each of these devices may be used independently, or in collaboration with each other, to determine an identity of a person and/or a mobile device carried by the person that are in or near premises 102. The term “in or near” refers to a person who is physically present inside premises 102 or not within premises 102 but within range of person/mobile identification device 114. Identification information from person/mobile identification device 114 is sent either directly to central security monitoring device 114 via LAN 128, or to a cloud-based cellular carrier server 118 via a wide-area network 120, such as the Internet. In either case, central security monitoring device 114 receives the identification information and identifies authorized and unauthorized persons and/or their mobile devices. An authorized person or their mobile device is a trusted person and/or mobile device that is permitted to be within premises 102 when security system 100 is either in an armed-home mode or an armed-away mode. Examples of such persons/mobile devices comprise a homeowner, a business owner, a renter, family members and, in some cases, close friends of the aforementioned. Central security monitoring device 114 may be pre-programmed with a list of authorized persons and/or their mobile devices so that when security system 100 is an in armed-home or armed-away mode and intrusion is detected, central security monitoring device 114 can determines if the intruder is authorized to be present. If not, central security monitoring device 114 causes an escalated alarm response to occur, such as notifying a central monitoring center 122 and/or one or more authorized persons of the intrusion and/or causing one or more local alerts to be generated, such as sounding one or more loud sirens at premises 102, causing one or more strobe lights to flash at premises 102, or some other response to occur at premises 102. If intrusion is detected, but no unauthorized persons/mobile devices are in or near premises 102, then central security monitoring device 114 ignores the alarm signal(s) sent by one or more of the security sensors. “Ignoring” means not causing any of the aforementioned escalated alarm responses to occur.

The use of identification information of persons and/or their mobile devices may lower the incident of false alarms. Such false alarms may be caused by authorized persons inside premises 102 who open a monitored door or window and security system 100 is in an armed-home mode (where any motion sensors are disabled or otherwise ignored by central security monitoring device 114). False alarms may also be caused by authorized persons if they forget a password or authorization code used to deactivate security system 102 as they open a door or window monitored by a security sensor. Finally, false alarms can occur when an authorized person moves within or near premises 102 when security system 100 is set to armed-away mode, i.e., accidentally triggering a motion sensor inside premises 102. By knowing if an unauthorized person is in or near a monitored premises, alarm escalation can be avoided in a false alarm situation.

Remote monitoring center 122 typically provides security monitoring services for homes and businesses equipped with security systems such as the one shown in FIG. 1. Remote monitoring center 122 is typically staffed with live personal who receive notifications from security systems via wide-area network 120, or by other means, such as cellular or PSTN networks. The notifications result as central security monitoring device 114 receives one or more alarm signals from one or more security sensors in security system 100 while security system 100 is in an armed-home or armed-away mode. In other embodiments, central security monitoring device 114 comprises a hub, or gateway, that simply passes alarm signals from the security sensors to a remote server 124 across wide-area network 120 (or other wide-area communication network), where remote server 124 processes the alarm signals and provides one or more escalated alarm responses to central security monitoring device 114 and/or remote monitoring center 122. In this embodiment, central security monitoring device 114 additionally passes signals from person/mobile identification device 114 to remote server 124 for use in determining whether a false alarm has occurred, again based on a determination whether an unauthorized person and/or mobile device is in or near premises 102

Cloud based, cellular carrier server 130 is coupled to wide-area network 120 and used to determine identification information (i.e., IMSI, IMED, etc.) in an embodiment where person/mobile identification device 114 comprises a cellular receiver or transceiver. Cellular carrier server 130 may be managed by a cellular carrier (such as AT&T, Verizon, etc.) and comprises a computer server for receiving standardized cellular messaging from mobile devices in or near premises 102 via person/mobile identification device 114 , for isolating the identification information, and for providing the identification information to central security monitoring device 114 via wide-area network 120 and LAN 128 or to person/mobile identification device 114 , which passes the identification information to central security monitoring device 114. The identification information from cellular carrier server 130 is sent upon a request from central security monitoring device 114, upon determination by cellular carrier server 130 or at regular time intervals, such as once per hour.

Keypad 126 is a remote user interface, wired or wirelessly coupled to central security monitoring device 114. Keypad 126 may be conveniently located near an entry door and used to arm and disarm the security system, deactivate an escalated response after triggering a false alarm and display status information to a user. Keypad 126 typically also comprises an audio alert device, such as a speaker and related circuitry, to provide audio warnings and notifications to users. Keypad 126 may be referred to herein as an audio alert device. Deactivating the escalated response occurs comprises deactivating security system 102, or cancelling an upcoming escalated response, after a false alarm has been triggered. Typically, a predetermined time window, such as 30 seconds, is provided to enter a deactivation code into keypad 126. During this time, keypad 126 may emit a one or more sounds, indicating a countdown of this time period. If a deactivation code is received before the time window expires, keypad 126 transmits it to central security monitoring device 114, whereupon central security monitoring device 114 cancels the escalated response if the deactivation code matches an code stored in a memory of central security monitoring device 114.

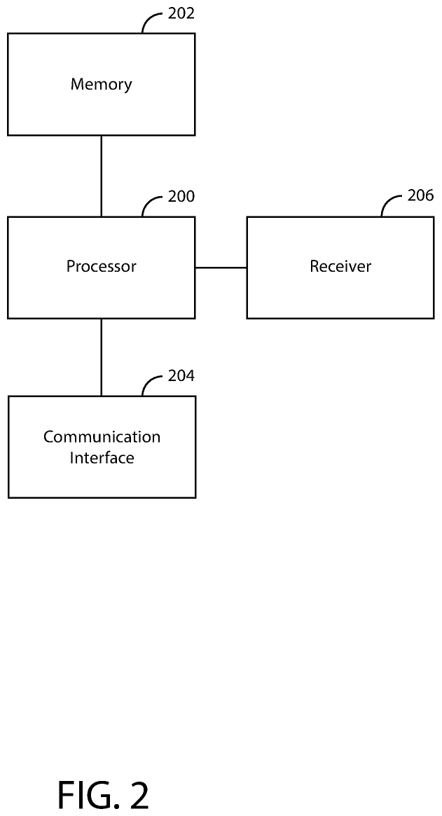

FIG. 2 is a functional block diagram of one embodiment of central security monitoring device 114 in which central security monitoring device 114 identifies people and/or their mobile devices in or near premises 102. Specifically, FIG. 2 shows processor 200, memory 202, communication interface 204, and a receiver 206. It should be understood that the functional blocks may be coupled to one another in a variety of ways, and that not all functional blocks necessary for operation of the barrier alarm device are shown (such as a power supply), for purposes of clarity. In other embodiments, central security monitoring device 114 comprises an Internet-connected “hub” or “gateway” that merely routes signals between the security sensors and remote server 124. In this embodiment, central security monitoring device 114 may connect to peripheral devices, such as one or more lights and/or sirens, so that activation of such lights and/or sirens can be accomplished by remote server 124. References made to “central security monitoring device 114” herein shall also include devices such as a hub, gateway, or the like.

Processor 200 is configured to provide general operation of central security monitoring device 114 by executing processor-executable instructions stored in memory 202, for example, executable code. Processor 200 typically comprises a general purpose processor, such as a 4286 Group microcomputer from Renesas Electronics of Tokyo, Japan, although any one of a variety of microprocessors, microcomputers, and/or microcontrollers may be used alternatively. Processor 200 is typically selected based on processing power, size and cost.

Memory 202 is electronically coupled to processor 200, comprising one or more non-transitory information storage devices, such as RAM, ROM, EEPROM, flash, SD, XD, or other type of electronic, optical, or mechanical memory device. Memory 202 is used to store processor-executable instructions for operation of central security monitoring device 114 as well as any information used by processor 200, such as threshold information, parameter information, identification information, a list of authorized persons and/or mobile devices, a current list of persons and/or mobile devices in or near premises 102, etc.

Network interface 204 comprises hardware and circuitry necessary for central security monitoring device 114 to wirelessly communicate with other devices, such as person/mobile identification device 114 and remote monitoring center 122 via LAN 128. Such hardware and circuitry is well-known in the art.

Receiver 206 is electronically coupled to processor 200, comprising circuitry needed to wirelessly communicate with the security sensors of security system 100. Such circuitry is well known in the art.

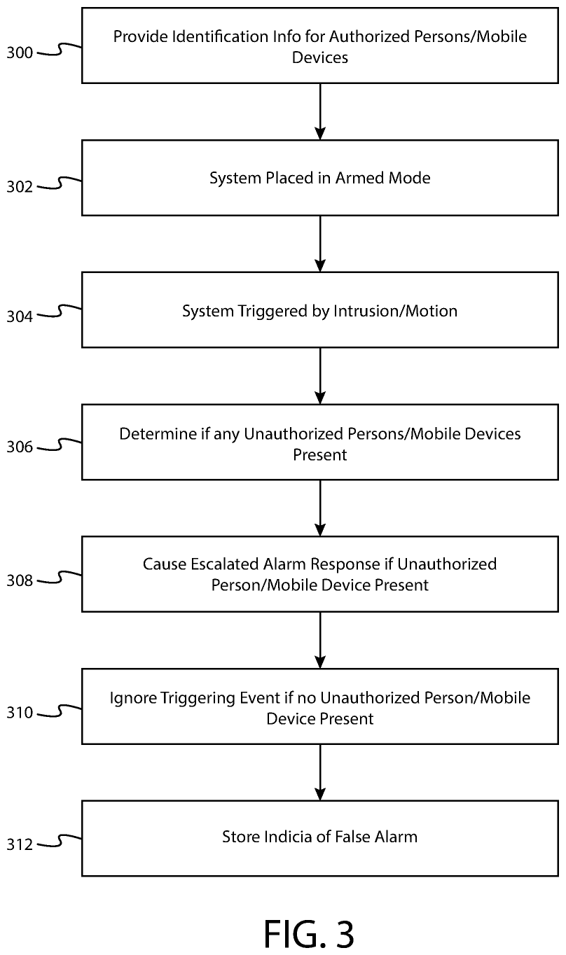

FIG. 3 is a flow diagram illustrating one embodiment of a method performed by central security monitoring device 114 or remote server 124, for reducing or preventing the occurrence of false alarms. It should be understood that in some embodiments, not all of the steps shown in FIG. 3 are performed. It should also be understood that the order in which the steps are carried out may be different in other embodiments.

At block 300, central security monitoring device 114 is programmed with a list of one or more authorized persons and/or their mobile devices. “Authorized persons and/or their mobile devices” means people that are known and trusted to be inside a home or business when security system 100 is armed, identified in some embodiments by their mobile devices that are normally carried by them. However, in other embodiments, persons may be identified without having a mobile device, such as the case when person/mobile identification device 114 comprises a camera. For example, a family of 4 residing in a home would all be authorized persons to be in their home when security system 100 is armed, along with some of their trusted friends and other trusted extended family members. An identification of each of these authorized persons and/or their mobile devices, such as their names or smart phone identification numbers, is entered by an owner or other user of security system 102, typically via an app running on a mobile phone. Identification information of each authorized person may comprise a person's name, a digital photo of the person, a social security number and/or other unique identification code or the person, physical characteristics such as height, weight, hair color, eye color, etc. Identification information of each authorized mobile device may comprise an IP address of the mobile device, a MAC address, a phone number, an international mobile subscriber identity (IMSI)), an International Mobile Equipment Identity IMEI, and/or some other identification that uniquely identifies the mobile device. Processor 200 stores the identification information of authorized persons and/or their mobile devices in memory 202.

At block 302, security system 100 is placed into either an armed-home mode or an armed-away state by an authorized person. In the armed-home mode, used primarily during sleeping hours when authorized persons are at home, central security monitoring device 114 typically reacts only to alarm signals sent from perimeter sensors, such as door and window sensors, but does not react to alarm signals sent by any motion sensors inside premises 102. In this way, people are free to move about inside premises 102 without causing an escalated alarm response. In the armed-away mode, used when monitored premises 102 is vacant, central security monitoring device 114 monitors all of the security sensors to detect an alarm signal sent by any one of them. In some embodiments, central security monitoring device 114 may delay escalation of received alarm signals from certain sensors, such as door or window sensors that monitor often-used doors and windows. In this way, if a false alarm is triggered, an authorized person can cancel alarm escalation, typically by entering a security code into keypad 126, before a predetermined time window expires, typically 30 seconds.

At block 304, security system 102 is triggered when someone opens a door or a window, moves in an area monitored by a motion sensor, or otherwise causes a security sensor of security system 102 to trigger. When that happens, the triggered security sensor transmits a wireless alarm signal to central security monitoring device 114, alerting central security monitoring device 114 of the triggering, and provides certain information that identifies the particular security sensor that sent the alarm signal.

At block 306, in one embodiment, central security monitoring device 114 receives the alarm signal and, in response, determines if there are any unauthorized persons and/or mobile devices in or near premises 102. Processor 200 determines this by either checking memory 202 to see if an indication has been previously stored, indicating the presence of one or more unauthorized persons, or making the determination in response to receiving the alarm signal, as described below.

In one embodiment, person/mobile identification device 114 comprises one or more Bluetooth receivers. The term “Bluetooth receiver” refers to any wireless receiver that adheres to IEEE 802.15.1 standard or conforms to a standard promulgated by the Bluetooth Special Interest Group. All Bluetooth standards are incorporated by reference herein. Such receivers typically operate using short-wavelength UHF radio waves in the industrial, scientific and medical radio bands, from 2.402 GHz to 2.480 GHz, and building personal area networks (PANs). In this embodiment, when a person is in or near premises 102, i.e., within range of person/mobile identification device 114, person/mobile identification device 114 sends and/or receives one or more Bluetooth advertising packets from the person's mobile device, if such a mobile device is equipped with Bluetooth technology and if Bluetooth is enabled on the device. Bluetooth devices typically transmit these advertising packets at fixed time intervals, to inform other Bluetooth devices nearby that another Bluetooth-capable device is present.

In this embodiment, the person's mobile device transmits one or more advertising packets, and the advertising packet(s) is/are received by person/mobile identification device 114 and provided to processor 200. A variety of adverting packets are defined in various Bluetooth standards. For Bluetooth Low Energy (BLE), each advertising packet comprises a protocol data unit or PDU. There are a number of different PDU types, including ADV_IND (Type: 0000), which describes a generic advertisement and usually the most common. It is generic in that it is not directed to any particular other Bluetooth device and it is connectable, meaning that a central device, such as central security monitoring device 114, can connect to the mobile device. However, connecting to a mobile device is generally not necessary in order for central security monitoring device 114 to determine an identity of the mobile device.

Another PDU that can be used is the ADV_NONCONN_IND (Type: 0b0010).

This is a non-connectable, undirected advertising packet where the mobile device cannot be connected to and cannot respond to a scan request, as described below.

Another PDU that can be used, by central security monitoring device 114, is the SCAN_REQ (Type: 0b0011), which is sent by central security monitoring device 114 requesting a scan response from any Bluetooth device in range of central security monitoring device 114.

Yet another PDU that can be used is the ADV_SCAN_IND (Type: 0b0110), which is scannable, undirected advertising in which the mobile device cannot be connected to but the mobile device can respond to a scan request from central security monitoring device 114.

Each of the PDU,'s, above, comprises a payload comprising an advertisement address (AdvA) of six bytes. This address may be referred to herein as the Bluetooth MAC address, and is an address that uniquely identifies the mobile device. In one embodiment, processor 200 uses the AdvA in received advertisement packets to identify the mobile device.

Thus, the person's mobile device may transmit Bluetooth advertising packets to inform central security monitoring device 114, via person/mobile identification device 114, indicating that the person's mobile device is in or near premises 102. Conversely, person/mobile identification device 114 may transmit advertising packets which may be received by the person's mobile device, and a response may be generated that contains the Bluetooth MAC address.

In another embodiment, person/mobile identification device 114 comprises one or more cameras. In this embodiment, persons are identified using one or more digitized still or video images generated by the one or more cameras, provided to central security monitoring device 114, or to remote server 124, for processing. Central security monitoring device 114 or remote server 124 may employ any number of known image/video processing techniques to identify persons as they enter or move about premises 102. In this embodiment, still or video digital images may be pre-provided to central security monitoring device 114 or remote server 124 of any authorized persons for use by central security monitoring device 114 or remote server 124 to help identify those who are not authorized to be within premises 102 when security system 100 is armed.

In yet another embodiment, person/mobile identification device 114 comprises a cellular receiver or transceiver that is capable of communicating with a person's mobile device using cellular protocols, such as 4G LTE and 5G NR. In one embodiment, person/mobile identification device 114 comprises a 4G or 5G femtocell, which is a small, low-power cellular base station, typically designed for use in a home or small business, that communicates with mobile devices wirelessly via cellular signals, and with cloud based, cellular carrier server 130 (i.e., the “backhaul”) via a broadband connection, i.e., via LAN 128 and wide-area network 120. In another embodiment, for the backhaul, a femtocell can communicate with the cellular carrier server 130 via 4G or 5G cellular signals and may additionally convert cellular signals from one protocol into another, i.e., acting as a 4G-5G cellular converter, where a person's mobile phone uses 4G cellular signals and the femtocell uses 5G cellular signals to communicate with cellular infrastructure. In this embodiment, when a person carrying a mobile phone or other mobile cellular device is in or near premises 102, the mobile device may detect the presence of person/mobile identification device 114 using cellular registration techniques well known in the art. As part of this registration process, an identification of the mobile device (such as the device's IMSI, IMED, etc.) is provided to person/mobile identification device 114 when the mobile device “attaches” itself to person/mobile identification device 114 (for example, in an “Attach” message used in LTE cellular networks), which passes it either directly to central security monitoring device 114, or to cellular carrier server 130, where the mobile device identification information is determined by cellular carrier server 130 and then passed to central security monitoring device 114 via wide-area network 120 and LAN 128, or to person/mobile identification device 114 via cellular signals, and then to central security monitoring device 114 via LAN 128. All cellular standards are incorporated by reference herein.

In any case, processor 200 determines identities of people and/or their mobile devices who are in or near premises 102 using any of the aforementioned techniques and stores a result of this determination in memory 202. In one embodiment, processor 200 makes such determinations only when security systems 100 is armed while in other embodiments, determinations are performed just after an alarm signal is received by central security monitoring device 114, or, in yet still other embodiments, on a continuous basis. Typically, processor 200 compares the identification information of any newly-discovered person or mobile device to the list of authorized persons or mobile devices previously stored in memory 202 to make this determination. If a match is not found, processor 200 considers the newly-discovered person/mobile device to be unauthorized and stores an indication in memory 202 that an unauthorized person and/or mobile device is present in or near premises 102. The indication may be a list separate from the list of authorized persons/mobile devices stored in memory 202 of any unauthorized person/mobile device in or near premises 102. In another embodiment, the name or identification information of the unauthorized person/mobile device is stored in memory 202 in association with an indication, such as a “1”, that an unauthorized person/mobile device is in or near premises 102. Multiple indications may be stored, one for each unauthorized person/mobile device in or near premises 102.

When an unauthorized person and/or the person's mobile device leaves premises 102 and is outside the range of person/mobile identification device 114, central security monitoring device 114 may detect that the person and/or mobile device is no longer in or near premises 102, and in response, remove any indication stored in memory 202 of the unauthorized person who just left premises 102. In the case where multiple indications of unauthorized persons/mobile devices may be stored in memory, processor 200 determines that there are no unauthorized persons and/or mobile devices when the last unauthorized person/mobile device in no longer in or near premises 102.

In response to receiving the alarm signal from one or more of the security sensors, processor 200 determines if there are any unauthorized persons and/or mobile devices in or near premises 102, in one embodiment, by reading memory 202 to determine if there is an indication previously stored of any unauthorized persons in or near premises 102. In another embodiment, processor 200 makes a determination in response to receiving one or more alarms signals, in one embodiment, by causing person/mobile identification device 114 to “ping” any devices within range of person/mobile identification device 114 for a response, and comparing any identification received by person/mobile identification device 114 in response to the ping(s) to the list of authorized persons/mobile device stored in memory 202.

At block 308, if there are any unauthorized persons and/or mobile devices in or near premises 102, processor 200 causes one or more escalated alarm responses to occur. In another embodiment, the escalated alarm response is only initiated when there are one or more unauthorized persons/mobile devices inside of premises; the escalated alarm response does not occur if unauthorized persons/mobile devices are discovered near monitored premises 102. In one embodiment, processor 200 causes one or more escalated alarm responses to occur only after expiration of a predetermined time window occurs, such as 30 seconds, allowing an authorized person a short time period to enter a cancellation or deactivation code, cancelling the escalated alarm response, disarming or otherwise deactivating security system 102.

At block 310, if there are no unauthorized persons and/or mobile devices in or near premises 102, processor 200 ignores the alarm signal(s) received from one or more of the security sensors, i.e., fails to cause any escalated alarm responses to occur. In another embodiment, processor 200 causes one or more escalated alarm responses to occur only after expiration of a predetermined time window occurs, such as 30 seconds, allowing an authorized person a short time period to enter a cancellation or deactivation code, cancelling the escalated alarm response, disarming or otherwise deactivating security system 102.

At block 312, each time that a false alarm is detected, i.e., processor 200 receives an alarm signal from one of the security sensors and no unauthorized persons/mobile devices are in or near premises 102, processor 200 may record indicia of the false alarm and store it in memory 202. For example, the indicia may comprise a date and time that the false alarm occurred, a listing of the mobile devices in the list of authorized mobile devices in memory 202 at the time the false alarm occurred, and a total number of false alarms triggered over a predetermined time period, such as 1 week, 1 month, 1 year, etc. Such indicia may be provided to any authorized person at regular time intervals, such as once per week or once per month, or upon request of an authorized user, typically via an app running on a mobile device.

The methods or algorithms described in connection with the embodiments disclosed herein may be embodied directly in hardware or embodied in processor-readable instructions executed by a processor. The processor-readable instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components.

Accordingly, an embodiment of the invention may comprise a computer-readable media embodying code or processor-readable instructions to implement the teachings, methods, processes, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

I claim:

1. A security system, comprising:
one or more security sensors located in and around a monitored premises;
a mobile identification device for determining an identification of a mobile device in or near a monitored premises;
a central security monitoring device, comprising:
a receiver for receiving alarm signals from the one or more security sensors;
a non-transient memory for storing processor-executable instructions and a list of authorized mobile devices that are authorized to enter the monitored premises; and
a processor, coupled to the receiver and the memory, for executing the processor-executable instructions that causes the central security monitoring device to:
receive an alarm signal from one of the security sensors indicating intrusion into the monitored premises;
in response to receiving the alarm signal, determine if there are any unauthorized mobile devices in or near the monitored premises; and
ignore the alarm signal when no unauthorized mobile devices are in or near the monitored premises.

2. The security system of claim 1, wherein the processor-executable instructions that cause the central security monitoring device to determine if there are any unauthorized mobile devices in or near the monitored premises comprise instructions that causes the central security monitoring device to:
monitor, via the mobile identification device, the monitored premises to determine an identification of a mobile device in or near the monitored premises;
compare the identification of the mobile device in or near the monitored premises to the list of authorized mobile devices stored in the memory;
identify the mobile device as an unauthorized mobile device when the identification of the mobile device is not found in the list of authorized mobile devices stored in the memory; and
store an indication in the memory that an unauthorized mobile device is in or near the monitored premises.

3. The security system of claim 2, comprising further processor-executable instructions that causes the central security monitoring device to:
determine that the unauthorized mobile device is no longer in or near the monitored premises; and
in response to determining that the unauthorized mobile device is no longer in or near the monitored premises, remove the indication in the memory of the unauthorized mobile device being in or near the monitored premises.

4. The security system of claim 1, comprising further processor-executable instructions that causes the central security monitoring device to:
receive identification information of an authorized mobile device; and
store the identification information in the list of one or more authorized identification codes in the memory.

5. The security system of claim 1, wherein the mobile identification device comprises one or more Bluetooth receivers for receiving an advertisement address from a mobile device carried by a person in or near the monitored address.

6. The security system of claim 1, wherein the mobile device comprises a cellular phone, and the mobile identification device comprises a cellular receiver for receiving a mobile identification number from cellular phone.

7. The security system of claim 6, wherein the mobile identification number is received during an Attach message transmitted from the mobile device to the mobile identification device.

8. The security system of claim 1, further comprising:
a cloud-based, cellular carrier server coupled to a mobile identification device located at the monitored premises, the mobile identification device for forwarding cellular signals received from a mobile device located in or near the monitored premises to the cloud-based, cellular carrier server, the cloud-based, cellular carrier server for receiving the cellular signals from the mobile identification device, for determining identification information of the mobile device from one or more of the received cellular signals, and for providing the identification information to the central security monitoring device via a wide-area data network;
wherein the processor-executable instructions that cause the central security monitoring device to determine if there are any unauthorized mobile devices in or near the monitored premises comprise instructions that causes the central security monitoring device to:
receive a notification from the cloud-based, cellular carrier server that a mobile device is in or near the monitored premises, the notification comprising a mobile identification number associated with the mobile device in or near the monitored premises;
compare the mobile identification number to the list of authorized mobile devices stored in the memory;
identify the mobile device as an unauthorized mobile device when the mobile identification number does not any of the authorized mobile devices stored in the memory; and
store an indication in the memory that an unauthorized mobile device is in or near the monitored premises.

9. The security system of claim 1, comprising further processor-executable instructions that causes the central security monitoring device to:
cause an escalated alarm response to occur when the alarm signal is received from one of the one or more security sensors and an unauthorized mobile device is in or near the monitored premises.

10. The security system of claim 9, further comprising:
an audio alert device coupled to the central security monitoring device;
wherein the processor-executable instructions that cause the central security monitoring device to cause an escalated alarm response to occur comprise instructions that causes the central security monitoring device to:
delay causing the escalated alarm response to occur;
cause an alert to be sounded via the audio alert device, warning that the security system will cause the escalated alarm response within a predetermined time period; and
cause the escalated alarm response if the central security monitoring device does not receive a code to deactivate the escalated alarm response within the predetermined time period.

11. A method, performed by a central security monitoring device, comprising:
receiving an alarm signal from a first security sensor monitored by the central security monitoring device, the alarm signal indicating intrusion into the monitored premises;
in response to receiving the alarm signal, determining if there are any unauthorized mobile devices in or near a monitored premises where the central security monitoring device is located; and
ignoring the alarm signal when no unauthorized mobile devices are in or near the monitored premises.

12. The method of claim 11, wherein determining if there are any unauthorized mobile devices in or near the monitored premises comprises:
monitoring, via a mobile identification device coupled to the central security monitoring device, the monitored premises to determine an identification of a mobile device in or near the monitored premises;
comparing the identification of the mobile device in or near the monitored premises to a list of authorized mobile devices stored in a memory of central security monitoring device;
identifying the mobile device as an unauthorized mobile device when the identification of the mobile device is not found in the list of authorized mobile devices stored in the memory; and
storing an indication in the memory that an unauthorized mobile device is in or near the monitored premises.

13. The method of claim 12, further comprising:
determining that the unauthorized mobile device is no longer in or near the monitored premises; and
in response to determining that the unauthorized mobile device is no longer in or near the monitored premises, removing the indication in the memory of the unauthorized mobile device being in or near the monitored premises.

14. The method of claim 11, comprising further processor-executable instructions that causes the central security monitoring device to:
receive identification information of an authorized mobile device; and
store the identification information in the list of one or more authorized identification codes in the memory.

15. The method of claim 11, wherein a mobile identification device coupled to the central security monitoring device provides the identification information, comprising one or more Bluetooth receivers for receiving an advertisement address from a mobile device carried by a person in or near the monitored address.

16. The method of claim 11, wherein the mobile device comprises a cellular phone, and a mobile identification device coupled to the central security monitoring device provides the identification information, comprising a cellular receiver for receiving a mobile identification number from cellular phone.

17. The method of claim 15, wherein the mobile identification number is received during an Attach message transmitted from the mobile device to the mobile identification device.

18. The method of claim 11, further comprising:
a cloud-based, cellular carrier server coupled to a mobile identification device located at the monitored premises, the mobile identification device for forwarding cellular signals received from a mobile device located in or near the monitored premises to the cloud-based, cellular carrier server, the cloud-based, cellular carrier server for receiving the cellular signals from the mobile identification device, for determining identification information of the mobile device from one or more of the received cellular signals, and for providing the identification information to the central security monitoring device via a wide-area data network;
wherein determining if there are any unauthorized mobile devices in or near the monitored premises comprises:
receiving the identification information of the mobile device in or near the monitored premises from the cloud-based, cellular carrier server;
comparing the mobile identification number to a list of authorized mobile devices stored in a memory of the central security monitoring device;
identifying the mobile device as an unauthorized mobile device when the mobile identification number does not any of the authorized mobile devices stored in the memory; and
storing an indication in the memory that an unauthorized mobile device is in or near the monitored premises.

19. The method of claim 11, further comprising:
causing an escalated alarm response to occur when the alarm signal is received from one of the one or more security sensors and an unauthorized mobile device is in or near the monitored premises.

20. The method of claim 19, wherein the causing an escalated alarm response to occur comprises:
delay causing the escalated alarm response to occur;
causing an alert to be sounded via an audio alert device coupled to the central security monitoring device, warning that the security system will cause the escalated alarm response within a predetermined time period; and
causing the escalated alarm response if the central security monitoring device does not receive a code to deactivate the escalated alarm response within the predetermined time period.
